(19) United States
(12) Patent Application Publication
(10) Pub. No.: US 2007/0082969 A1
(43) Pub. Date: Apr. 12, 2007

(54) Poly (alkylene oxide) polymer-based pressure sensitive adhesive and tapes formed therefrom

(76) Inventors: Ranjit Malik, York, PA (US); Shayne D. Spence, Cayahoga, OH (US); Brian A. Harkins, Lakeview, NY (US)

Correspondence Address: BIRCH STEWART KOLASCH & BIRCH, PO BOX 747, FALLS CHURCH, VA, 22040-0747, US

(21) Appl. No.: 10/577,443

(22) PCT Filed: Oct. 27, 2004
(86) PCT No.: PCT/US04/35443

§ 371 Date: Apr. 27, 2006

Related U.S. Application Data
(60) Provisional application No. 60/514,556, filed on Oct. 27, 2003.

(51) Int. Cl. B29D 11/00

(52) U.S. Cl. 522/178

(57) ABSTRACT

A pressure sensitive adhesive is provided which is comprised of at least one radiation cured oligomer and/or monomer which is cured in situ on a substrate in the form of a coating. The adhesive comprises an insoluble polymer which comprises a plurality of polyether segments comprising —CₐH₂ₐO— repeat units, wherein a is an integer of 1 to 4, with the segments comprising from about 20 to about 85 percent by weight of polymer.

### BACKGROUND OF THE PRESENT INVENTION

This invention relates to a novel pressure sensitive adhesive based on the poly(alkylene oxide) polymer and radiation cure thereof.

Poly(alkylene oxide) has been used in the past to formulate adhesives, coatings, and release liners. However, the use of poly(alkylene oxide) as a radiation curable pressure sensitive adhesive is a novel application. This invention also relates to the manufacture of pressure sensitive adhesive tapes using radiation cure.

Pressure sensitive adhesives made from poly(alkylene oxide) are desirable because this material is very soft and conformable. Very low lamination pressure to achieve high quality lamination and the ease of removability are two unique attributes of this invention. Its ability to virtually apply itself to smooth surfaces enables its use in several application areas where pressure sensitive adhesives have not been used before with success.

One such area pertains to a self adhesive interface material to couple two fragile elements of a device, under little or no pressure. An example of the device can be, but is not limited to, an optical light guide assembly. One such specific example is the coupling of a touch screen to the LCD panel. In this embodiment, the coupling material should have excellent light transmission, form a bond with minimal air entrapment, allow repeated removability for work up, have enough bond strength to withstand the weight of the touch screen, and resist displacement under normal handling. Optical assembly applications should also meet the criteria for optical clarity, high shear resistance, clean removability, easy repositionability, and be silicone-free. It is an object of the present invention to create an adhesive system that will offer the above mentioned characteristics in a cohesive pressure sensitive adhesive film.

Previous approaches where poly(alkylene oxide) has been used in pressure sensitive adhesive compositions have relied on either thermal or moisture cure chemistry. Both these chemistries require elevated temperatures or extended cure cycles to convert the formulation to a pressure sensitive adhesive. Certain heat sensitive materials and substrates cannot withstand the temperature required in the curing reaction. The thermal reactions are relatively slow which requires long ovens and/or long curing time for the reaction. Long cure cycles are at a competitive disadvantage in a commercial manufacturing environment. In contrast, radiation does not rely on heat for the curing reaction. Heat sensitive substrates that are difficult to process thermally can be easily used in radiation curing. Radiation curing is also a fast process. Therefore, the curing oven length is short resulting in floor space saving and increased productivity.

Poly(alkylene oxide) is used in the prior art to make self-adhesive hydrogels. Hydrogels contain water as a solvent in its composition. This water remains trapped in the matrix of the adhesive. However, water tends to evaporate with time leading to drying of the hydrogel and loss in properties. Also, the presence of water in hydrogels is detrimental to the applications discussed above. Therefore, hydrogels are ill-suited for use in these applications.

Known prior art includes the following:

Japanese patent No. JP 01275684 describes a mixture of siloxanepolyoxyalkylene and an acrylic polymer in a pressure sensitive adhesive composition. This patent describes a moisture cured composition.

Japanese patent No. JP 03122180 relates to a pressure sensitive adhesive tape with high elongation and strength. The adhesive dimethoxysilyl group containing propylene oxide polymer is solvent cast. The adhesive is a moisture cured composition and requires thermal energy for cure.

European patent No. EP 894841 describes a polyurethane pressure sensitive adhesive prepared from polyols and diisocyanates. However, the disclosed composition requires thermal initiation.

European patent No. EP 295330 relates to an acrylic pressure sensitive adhesive which contains polypropylene glycol. In contrast to the present invention, this patent describes a moisture cured composition that is cast from solvent.

U.S. Pat. No. 5,319,020 describes an emulsion pressure sensitive adhesive formed in the presence of polyalkylene oxide using a thermal initiation technique. This pressure sensitive adhesive is not curable and is designed to re-disperse in water.

U.S. Pat. No. 4,707,532 relates to the copolymerization of blocked polyisocyanates containing poly(propylene oxide). However, the disclosed composition requires thermal initiation.

Japanese patent No. JP 59-170168 relates to a pressure sensitive adhesive containing poly(propylene oxide). However, it is a moisture cured system and requires thermal initiation. It also requires the composition to be cast out of solvent.

Japanese patent No. JP 59-074149 describes a curable resin composition containing polyethers. The patent describes a thermal curing composition cast from solvent containing formulation.

Japanese patent Nos. JP 58093774 and JP 57109878 describe a thermally curable pressure sensitive adhesive using polyoxypropylene glycol and isocyanate.

Japanese patent No. JP 57109877 relates to pressure sensitive adhesives containing polyether diols. This patent describes an isocyanate based thermal cure composition.

Japanese patent No. JP 3-118431 describes the use of a polymeric gel for use as an interface material between the touch panel and the display. The patent further discloses that the gel material is comprised of polyurethane.

Japanese patent No. JP 2003-238915 describes the use of a double-sided pressure sensitive adhesive for the bonding of touch panel to the display screen.

### SUMMARY OF THE INVENTION

A pressure sensitive adhesive is thus provided comprised of at least one radiation cured oligomer and/or monomer, said adhesive comprising an insoluble polymer which comprises a plurality of polyether segments comprising —CₐH₂ₐO— repeat units, wherein a is an integer of 1 to 4, said segments comprising from about 20 to about 85 percent by weight of said polymer.

Adhesive tapes may be formed from the pressure sensitive adhesive which may be used with advantage in light guides, in the assembly of touch screens for liquid crystal display screens, in the assembly and mounting of removable graphics on a rigid or flexible substrate, as a protective covering for various components, or as a bonding agent for bonding transparent labels to glass or plastic surfaces.

A method of forming the pressure sensitive adhesive of the present invention is also provided comprising providing at least one radiation-curable oligomer and/or monomer on a substrate, said oligomer or monomer comprising a plurality of polyether segments comprising —CₐH₂ₐO— repeat units, wherein a is an integer of 1 to 4, and radiation-curing said oligomer and/or monomer in situ on said substrate to form an insoluble polymer, wherein said segments comprise from about 20 to about 85 percent by weight of said resulting polymer.

### DETAILED DESCRIPTION OF THE INVENTION

The pressure sensitive adhesive of the present invention comprises at least one radiation-cured oligomer and/or monomer, said adhesive comprising an insoluble polymer which comprises a plurality of polyether segments comprising —CₐH₂ₐO— repeat units, wherein a is an integer of 1 to 4, said segments comprising from about 20 to about 85 percent by weight of said polymer, as well as an adhesive tape formed therefrom, and a method of making the adhesive.

The pressure sensitive adhesive composition of the present invention is novel because it employs radiation to bring about the curing reaction. In contrast to thermal curing, radiation is a relatively low temperature curing technique. Heat sensitive substrates which are difficult to process thermally can be easily used in radiation curing. Another advantage of radiation curing is that it is a fast curing process. Radiation cure may be completed in a matter of seconds whereas thermal and moisture cure can take hours to complete. The present invention thus offers processing advantages.

Pressure sensitive adhesive tapes based on poly (alkylene oxide) chemistry also overcome the disadvantages of previous approaches based on conventional liquid adhesives and gels. Flexibility of the poly(alkylene oxide) backbone, even at low temperatures, allows the polymer to conform and spontaneously wet out on the substrate surface. The surface characteristics of these pressure sensitive adhesive tapes allow for the adhesive to be bonded and removed from the substrate repeatedly for repositioning or rework. Given their nature, the pressure sensitive adhesive tapes of the present invention do not suffer from cold flow or oozing. The adhesive tapes bond more aggressively to substrates than the gel materials. The adhesive tapes exhibit very good high temperature resistance. The ability to create a cohesive pressure sensitive adhesive film, capable of the above-mentioned properties, will fill many unmet needs in the adhesive market.

A conventional pressure sensitive adhesive must be rolled onto the substrate with some nip pressure to obtain defect free laminations. The rolling process is possible when the substrates are flexible. However, it becomes difficult to laminate rigid substrates using a roll process. It is here that the material of this invention provides significant advantage. The adhesive tape, when contacted with the substrate surface at one point, initiates a bond line that travels spontaneously under its own weight to increase the area of intimate contact until the entire substrate is bonded. Full surface coverage takes anywhere from seconds to a few minutes. The ability to form self-propagating bonds is novel to the pressure sensitive adhesive of this invention. A virtually bubble free lamination is obtained without the use of rolls and nip pressure. The combination of poly(alkylene oxide) polymer and the radiation cure process results in novel material properties not achieved in previous approaches.

The pressure sensitive adhesive of the present invention is also novel because it is a radiation-curable composition. Previous approaches where poly(alkylene oxide) has been used in pressure sensitive adhesive compositions have relied on either thermal or moisture cure chemistry. In contrast to thermal and moisture cure, radiation is a relatively low temperature curing technique. Heat sensitive substrates that are difficult to process thermally can be easily used in radiation curing. Another advantage is that radiation curing is a fast curing process.

The pressure sensitive adhesive of this invention is novel because it has the desirable properties of a hydrogel yet does not contain trapped water in its composition. The material of the present invention is a pressure sensitive adhesive with the compliance of a hydrogel. This invention combines the characteristics of pressure sensitive adhesives, especially the bond strength, with that of a gel material. Achieving the correct balance in the two behaviors through thermal or moisture cure chemistry is difficult.

The ability to remove and reposition a traditional pressure sensitive adhesive is a difficult characteristic to produce on a reliable basis without contamination through transfer of the adhesive to the adherend, causing permanent deformation in the adhesive tape or the substrate. Therefore, poly(alkylene oxide) extends the spectrum of performance properties beyond that obtained from the conventional polymers known to one skilled in the art of pressure sensitive adhesives.

Furthermore, liquid adhesives fail to address the need for removing and repositioning the adhesive bond. Similarly, during the bond formation the adhesive is uncured and very susceptible to flow and oozing. The gel systems fail to meet the important bond strength and cohesive strength criteria for the applications.

The composition of the current invention may be prepared by blending a poly(alkylene oxide) having functional terminal groups with a photoinitiator. Optionally, crosslinkers, tackifiers, plasticizers, and stabilizers can also be used in the blend to optimize the properties. The blend is coated on a substrate using suitable coating techniques prevalent in the industry and cured using a suitable radiation energy source.

The poly(alkylene oxide) of the present invention having the requisite functional terminal groups may be represented, for example, by one or more of the following formulae:

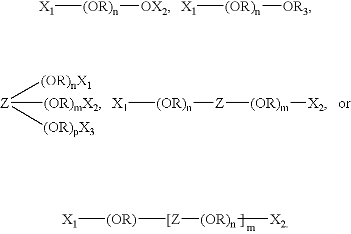

In the above formulae, X₁, X₂, X₃ are terminal groups at least one of which permits a curing reaction, and wherein X₁, X₂, X₃ may be the same or different from each other.

Additionally, n, m and p may range from 2 to 1000, R is a straight or branched alkylene group having the formula (CR₁R₂)_{q} where q is an integer from 1 to 4, and R₁ and R₂ may independently be hydrogen and C₁₋₃ alkyl. Exemplary alkylene groups include but are not limited to —CH₂CH₂—, —CH(CH₃)CH₂—, —CH(CH₂CH₃)CH₂—, —CH₂CH₂CH₂CH₂—, —CH(CH₃)CH(CH₃)—, —C(CH₃CH₃)CH(CH₃)—, and —CH₂C(CH₃)₂—.

R₃ can be any organic group, the identity of which is immaterial to practice of the present invention. Exemplary R₃ groups may include but are not limited to methyl and ethyl groups, although alkyl groups having from 2 to 20 carbon atoms may be employed without disadvantage, as well as amine or hydroxyl groups.

Z is an organic group that links the poly(alkylene oxide) chains. Exemplary Z groups include but are not limited to 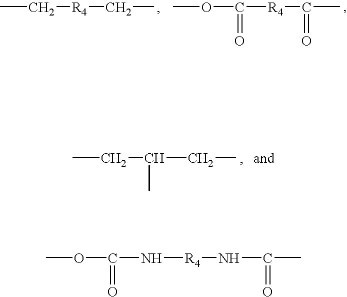
where R₄ is an organic group, the identity of which is immaterial to the practice of the invention. An exemplary R₄ group may include a straight chain, branched, alicyclic, or aromatic group having from 2 to 20 carbon atoms.

Formation of an optimal pressure sensitive adhesive depends on the cross-link density of the cured poly(alkylene oxide) film. As a general rule, too high a cross-link density will result in a loss of the pressure sensitive adhesive property characterized by undesirable peel, tack, and shear, whereas too low a cross-link density will result in a loss of the cohesive property. The cross-link density, in turn, will depend on the molecular weight and functionality of the uncured poly(alkylene oxide). The cross-link density will also depend on the mole ratio of the cross-linker in cases where an external cross-linker is added. The optimal cross-link density can be established after experimenting with the molecular weight of the uncured poly(alkylene oxide), and the cross-linker ratio. A non-tacky film is obtained if operating outside the pressure sensitive window. Typical molecular weight and cross-linker ratio is given in the example. A blend of poly(alkylene oxides) can also be used to lower the overall functionality in order to control the cross-link density.

The functional groups X₁, X₂, X₃ can be reacted by condensation, addition or ring opening reactions. These are called self-cross-linking systems. Exemplary self-cross-linking X₁, X₂, X₃ terminal groups include, but are not limited to, acrylate, methacrylate, epoxy, vinyl ether, and propenyl ether.

Alternatively, terminal groups X₁, X₂, X₃ may not be capable of self-cross-linking. In this case, an external cross-linking agent capable of reacting with X₁, X₂, X₃ is added. The choice of cross-linker will depend on the particular terminal group. Exemplary terminal groups X₁, X₂, X₃ which may react with an external cross-linking agent in a photoinduced reaction include epoxy, hydroxyl, alkene, thiol, (meth)acrylate groups, etc. Complementary functional terminal groups on the cross-linking agent include alcohol, epoxy, (meth)acrylate, thiol and alkene functionalities. For instance, if the terminal groups X₁, X₂, X₃ are hydroxyl groups, then an epoxy group-containing cross-linker can be used.

The identity of the cross-linking compound is not critical to the practice of the claimed invention. A variety of cross-linking compounds can be used, with the poly(alkylene oxide) and the cross-lining agent each having functionally compatible terminal groups. Cross-linking agents may be either mono- or di-functional. The identity of the cross-linking compound is not critical to the practice of the present invention.

Cross-linking compounds useful in the present invention include organic compounds having an oxirane ring, a hydroxyl group, an alkene group, a thiol group, or an amine group as functional groups polymerizable by ring opening or addition.

For example, organic compounds having an oxirane ring can be used as a cross-linker when the X₁, X₂, X₃ groups are hydroxyl. Oxirane ring materials include monomeric epoxy compounds and epoxides of the polymeric type and can be aliphatic, cycloaliphatic, aromatic or heterocyclic, as well as mixtures thereof. These materials generally have, on average, at least 1 polymerizable epoxy group per molecule, and preferably at least about 1.5 polymerizable epoxy groups per molecule. The polymeric epoxides include linear polymers having terminal epoxy groups (e.g., a diglycidyl ether of a polyoxyalkylene glycol), polymers having skeletal oxirane units (e.g., polybutadiene polyepoxide), and polymers having pendant epoxy groups (e.g., a glycidyl methacrylate polymer or copolymer).

Exemplary epoxy-containing materials include those which contain cyclohexene oxide groups such as the epoxycyclohexanecarboxylates, such as 3,4-epoxycyclohexylmethyl-3,4-epoxycyclohexanecarboxylate, 3,4-epoxy-2-methylcyclohexylmethyl-3,4-epoxy-2-methylcyclohexane carboxylate, bis(3,4-epoxycyclohexyl)adipate and bis(3,4-epoxy-6-methylcyclohexylmethyl)adipate.

One skilled in the art can readily determine the identity of suitable epoxy compounds for use in the present invention. Reference is made to U.S. Pat. Nos. 3,117,099 and 3,018,262 in this regard, herein incorporated by reference.

When employed, the molar ratio of cross-linking compound to poly(alkylene oxide) ranges from about 0.5:1 to about 150:1.

In a preferred embodiment, an epoxy cross-linking compound is reacted with poly(alkylene glycol) to form a pressure sensitive adhesive. The mixture is coated on a flexible substrate to form a coating. The coating is exposed to the radiation source for a period of time (e.g., 1 second to 10 minutes) sufficient to result in cross-linking of the poly(alkylene oxide) whereby the pressure sensitive adhesive tape is formed. The period of time required is dependent upon the type of reactants and the photoinitiator employed, the distance of the radiation source from the coating, etc.

The radiation-cured polymer comprises from about 20 to about 85 percent by weight of polyether segments, preferably from 35 to 85 percent by weight.

The requisite curing reaction can occur by means of photoinduced reactions of the terminal groups. The class of reactions can range from cationic to anionic to free-radical. One skilled in the art can determine suitable photoinitiators, cross-linkers, and reaction conditions.

In the present invention the term “radiation” means light rays, such as ultraviolet and visible rays, or ionizing radiation such as electron beam. Preferably, ultraviolet lamps are used which emit UV light in the wavelength range absorbed by the particular photoinitiator used. These include medium pressure mercury lamps and low intensity fluorescent lamps, each having various emission spectra and emission maxima between 240 and 400 nanometers. Commercially available microwave powered lamps available from Fusion UV Systems may be used.

If the composition is cured by exposure to non-ionizing radiation, such as by UV radiation, then a photoinitiator is also present. The photoinitiator, if present, is employed in a concentration of from about 0.1 to 10 weight percent, preferably from 0.5 to 5 weight percent based on the weight of the crosslinking compound.

The photoinitiators which are employed in a cationic reaction system are well known to those skilled in the art. Such photoinitiators include but are not limited to onium salt photoinitiators of the formula Ar+MF₆— where Ar is a mixed aryl sulfonium or mixed aryl indonium and M is phosphorous, arsenic or antimony. Exemplary photoinitiators include triarylsulfonium complex salts (U.S. Pat. No. 4,231,951); aromatic sulfonium or iodonium salts of halogen-containing complex ions (U.S. Pat. No. 4,256,828); aromatic onium salts of Group IVA elements (U.S. Pat. No. 4,058,401 and 4,138,255).

A typical free radical system will consist of a poly(alkylene oxide) where X₁, X₂, X₃ are acrylic groups. These groups can be cross-linked in the presence of a free-radical initiator and radiation. Typical free-radical initiators can be selected from either the class of α-cleavage or hydrogen abstraction initiators. Exemplary α-cleavage initiator would be hydroxycyclohexyl phenyl ketone and benzyl dimethyl ketal. Exemplary hydrogen abstraction initiator would be benzophenone and isopropylthioxanthone.

The adhesive composition of the present invention may also comprise up to about 50% by weight of an acrylate-containing component. Such components may be comprised of a monomer having an acrylic functional group. Alternatively, such components may comprise an oligomer or polymer derived from the reaction of acrylic monomers. Typical acrylic monomers include but are not limited to butyl acrylate, 2-ethylhexyl acrylate, methyl methacrylate, and acrylic acid. The acrylate component may co-react with the polyether when, for example, monomeric acrylates are used. In the case of oligomeric and polymeric acrylates, such materials will merely be blended with the polyether component as opposed to being reacted therewith.

Optionally, tackifiers and plasticizers may be added to the adhesive mixture to modify the adhesive properties. Such components, when employed, are generally present in amounts ranging from about 15% to about 45% by weight, optionally from about 15% to about 35% by weight.

Conventional tackifiers and plasticizers may be employed. Exemplary tackifying compounds include but are not limited to terpene phenolics, alpha methyl styrene resins, rosin derived tackifiers, monomeric alcohols, oligomeric alcohols, oligomeric glycols, and mixtures thereof. Exemplary plasticizers include but are not limited to terpene phenolics, rosin-derived plasticizers, polyglycols, and mixtures thereof.

### EXAMPLE

An exemplary adhesive formulation is as follows:

| | |
|---|---|
| Multranol 3900 | 40 parts |
| UVR6128 | 60 parts |
| Sylvalite RE10L | 40 parts |
| UVI6976 | 1% by UVR6128 |

wherein Multranol 3900 is a tri-functional poly(alkylene oxide) molecular weight 4,800 from Bayer Corporation, UVR6128 is an epoxy compound (external cross-linker) from Dow Chemical Company, Sylvalite RE10L is a tackifier from Arizona Chemicals, and UVI6976 is a photoinitiator from Dow Chemical Company.

The above ingredients were mixed until a homogeneous blend was formed. The blend was coated on a PET film substrate and exposed to UV radiation until the coating was cured. The coating was considered cured when it did not transfer residue when touched with a thumb. The resulting adhesive exhibited a peel value against glass of 25-35 g/in.

Filler materials such as silicas, wood fibers, calcium carbonate and the like can be used to reinforce the system mechanically providing increased shear and tensile strength. Nickel, steel flakes, silver coated glass spheres, carbon black, and the like can be used to make the materials electrically conductive. Alumina, boron nitride, and the like can be used to make the material thermally conductive. Nanoparticle silicas and nanoparticle montmorollonite clays have also been found to be suitable fillers for decreasing moisture permeability through film.

Sensitizers such as anthracene and perylene may be incorporated into the formulations to allow UV pressure sensitive adhesives to cure under visible light or to extend the wavelength range required for curing. Amine accelerators may also be added to speed up the curing reaction.

Adhesion promoters may also be present in the adhesive composition. For example, conventional materials such as titanates, zirconates, and silicone coupling agents may be incorporated into formulation to improve adhesion to glass and metal substrates.

The adhesive tape of the present invention may take many forms. For example, the adhesive coating may be formed on one surface of a suitable backing material, with a second adhesive layer being formed on the opposing surface of the backing material.

Exemplary backing materials include a variety of polymeric films such as polyvinyl chloride, vinyl chloride-vinylidene chloride copolymer, vinyl chloride-vinyl acetate copolymer, vinyl chloride-acrylic acid copolymer, polyvinylidene chloride, polyolefins, polymethyl methacrylate, polyvinyl alcohol, polyamide, polyimide, polyamideimide, polyesters, polycarbonate, polyurethane, and cellulose acetate. A variety of non-polymeric films may also be employed.

The backing layer may also be pre-treated with a primer to enhance adhesion to the poly(alkylene oxide) adhesive of the invention.

The adhesive layer may also be formed on a release coated substrate so that the adhesive layer can be easily picked up from the substrate and transferred to another surface. Other embodiments may be apparent to those skilled in the art and which may fall within the scope of the invention.

The novel pressure sensitive adhesive of the present invention may be coated on one side of a tape backing material, with the other side having coated thereon a conventional pressure sensitive adhesive. Exemplary conventional pressure sensitive adhesives which may be so employed include but are not limited to tackified natural rubbers; synthetic rubbers; tackified styrene block copolymers; polyvinyl ethers; poly-alpha-olefins; vinyl copolymers; acrylic polymer, copolymer, and terpolymer adhesives; polyurethane polymers; heat-activated adhesives; and silicone adhesives.

Natural rubber adhesives generally comprise masticated rubber together with a suitable tackifying resin. Synthetic rubber elastomers are self-tacky, and comprise, for example, butyl rubber, copolymers of isobutylene, polyisobutylene, homopolymers of isoprene, polybutadiene, or styrene/butadiene rubber. Such rubber elastomers may contain a tackifier and/or plasticizer. Styrene block copolymers generally comprise elastomers of the A-B or A-B-A configuration, where A is a thermoplastic polystyrene block and B is a rubbery block of polyisoprene, polybutadiene or poly(ethylene/butylene).

Polyvinyl ether pressure sensitive adhesives generally comprise blends of vinyl methyl ether, vinyl ethyl ether or vinyl iso-butyl ether, or homopolymers of vinyl ethers and acrylates.

Acrylic pressure sensitive adhesives may comprise, for example, a C₃₋₁₂ alkyl ester component and a polar component such as (meth)acrylic acid, N-vinyl pyrrolidone, etc. Such adhesives may be tackified.

Poly-alpha-olefins adhesives comprise an optionally cross-linked C₃₋₁₈ poly(alkene) polymer, which is either self-tacky or may include a tackifier.

Silicone pressure sensitive adhesives comprise a polymer or gum constituent and a tackifying resin.

Such pressure sensitive adhesives are well known to one of ordinary skill in the art and may be easily selected by such persons for use in the present invention.

The poly(alkylene oxide) adhesive of the present invention may also be directly coated on a conventional pressure sensitive adhesive to form a two-layered tape without a separator film.

Applications envisioned for the present invention include, but are not limited to, display markets, advertising markets, protective coatings, temporary sealing of multiwell plates used in bioreactors, cell cultures and microfluidics, and transparent label markets. Radiation curing of poly(alkylene oxide) allows the adhesives to be coated free of solvent or water. Also, the adhesive can be coated directly on the delicate heat sensitive substrates. Radiation curing of poly(alkylene oxide) offers logistic advantage in manufacturing.

Decreasing the ratio of the cross-linker to poly(alkylene oxide) and adjusting the photoinitiator can slow the curing reaction to take place much slower after exposure to the radiation source. This is called “delay cure.” Delay cure systems are of interest because these provide time after exposure to UV before the composition comes to a full cure.

One specific application involves the bonding of flat panel displays and, more specifically, the bonding of touch screens to the glass of a liquid crystal display screen. The application process calls for minimal mounting pressure to protect the delicate screen components. Additionally, it is possible to remove the touch screen from the LCD for repositioning or repair. The rigidity of the two substrates requires an adhesive that can easily form bonds between the screens without the need for sustained pressure and yet be cleanly removed for rework. This adhesive film may also serve as a protective coating during the shipment of the screens between manufacturers.

Another application involves the bonding of graphic displays in the form of rigid, display advertisements. The adhesive film is applied to a rigid display screen that would then be applied to a smooth surface such as a window or a wall. These display screens could be preprinted with advertisements or act more like a projection screen whereby images could be projected directly onto the screen. This application would require the ability to bond two rigid substrates with minimal pressure to ensure complete contact between the substrates for optimal visual characteristics. The bond would need to withstand high shear stress, yet still be removable for repositioning of the screen or replacement of the advertisement.

Another application of the, pressure sensitive adhesive tape involves the protection of delicate surfaces during processing, shipping or repairs. The adhesive would be coated onto film substrates and then cut to fit the shape of the material. The material could then undergo additional processing, shipping or repair work without the possible scratching or scuffing during the work. Envisioned materials could include, but are not limited to, display screens such as cell phones, pda's, televisions, polished surfaces such as aluminum or finished surfaces such as woods, plastics and metals. The delicate nature of the materials dictates the need for an adhesive that will bond to the surface with minimal pressure and remain in place under shear stress yet be cleanly removable after the process or work is complete.

Another application is in the manufacture of a clear label for plastic or glass containers for the purpose of a transparent look on the container. The adhesive's ability to bond under minimal pressure will allow for maximum surface wetting of the contoured container. This characteristic again lends itself to fast production speeds either during in-line application or post-production labeling.

A further application is in the processing of small fragile components during manufacturing. Typically, small components such as computer chips and semi-conductors need to be held in place while a processing step is carried out. This processing step could be the etching of small components or bonding small components together to form a final assembly. The pressure sensitive adhesive tape would be used to secure the small components in place during the processing. Following the processing steps the components could be cleanly removed from the pressure sensitive adhesive tape and placed in the final product. This application requires very high shear strength coupled with low peel strength in the form of a cleanly removable adhesive film. These adhesives may require resistance to high temperature, resistance to chemicals, and the ability to resist spatial distortion.

Another application is for the sealing of multiwell plates used in bioreactors, cell cultures and microfluidic devices. The adhesive is required to temporarily seal the contents of individual compartments preventing cross contamination during the period of the test. However, high moisture and oxygen transmission through the adhesive is required to promote biological processes within the compartments to take place. The ability to reseal the wells after repeatedly extracting samples during the course of the test is desired. Resistance to autoclaving and biological fluids may also be desired.

Current offerings of pressure sensitive adhesives are not suitable for use in the above listed applications. Therefore, these applications are being served with either liquid adhesives, or gels. Liquid adhesives require a very slow application process followed by a curing cycle. Furthermore, the ability to remove and reposition a liquid adhesive bond is not possible. Out-gassing from the liquid adhesive is also a reason for concern in some bonding situations. Flow and oozing of the liquid prior to cure also poses a problem for many of the applications. On the other hand, gel systems exhibit a lack of cohesive strength and load bearing capability. This coupled with their lack of good bond formation makes them undesirable for many of the above-mentioned applications.

What is claimed is:

1. A pressure sensitive adhesive comprised of at least one radiation-cured oligomer and/or monomer, said radiation-cured oligomer and/or monomer comprising an insoluble polymer which comprises a plurality of polyether segments comprising —CₐH₂ₐO— repeat units, wherein a is an integer of 1 to 4, said segments comprising from about 20 to about 85 percent by weight of said polymer.

2. A pressure sensitive adhesive of claim 1, wherein said polyether segments are selected from the group consisting of —CH₂O—, —CH₂CH₂O—, —CH₂(CH₃)CHO—, —CH₂CH₂CH₂CH₂O—, —CH₂(C₂H₅)CHO—, and mixtures thereof.

3. A pressure sensitive adhesive of claim 1, wherein said polyether segments comprise from 35 to 85 percent by weight of said polymer.

4. A pressure sensitive adhesive of claim 1, comprising from about 15% to about 65% by weight of an epoxy containing compound.

5. A pressure sensitive adhesive of claim 1 comprising up to about 50% by weight of an acrylate-containing compound.

6. A pressure sensitive adhesive of claim 1 comprising from about 15% to about 45% by weight of tackifier.

7. A pressure sensitive adhesive of claim 6 comprising from about 15% to about 35% by weight of tackifier.

8. A pressure sensitive adhesive of claim 1 comprising from about 15% to about 45% by weight of a plasticizer.

9. A pressure sensitive adhesive of claim 8 comprising from about 15% to about 35% by weight of a plasticizer.

10. A pressure sensitive adhesive of claim 1 comprising from about 0.1% to about 3% by weight of an initiator.

11. A pressure sensitive adhesive of claim 4 wherein said epoxy containing compound is selected from the group consisting of aliphatic epoxides, cycloaliphatic epoxides, and epoxidized vinyl compounds.

12. A pressure sensitive adhesive of claim 6 wherein said tackifier is selected from the group consisting of terpene phenolics, alpha methyl styrene derived resins, rosin derived tackifiers, monomeric alcohols, oligomeric alcohols, and oligomeric glycols.

13. A pressure sensitive adhesive of claim 8 wherein said plasticizer is selected from the group consisting of terpene phenolics, rosin-derived plasticizers, and polyglycols.

14. A pressure sensitive adhesive of claim 10 wherein said initiator comprises an onium salt cationic photoinitiator.

15. A pressure sensitive adhesive of claim 10 wherein said initiator comprises a free radical photoinitiator.

16. A pressure sensitive adhesive of claim 1 wherein said oligomer or monomer is represented by one or more of the formulae 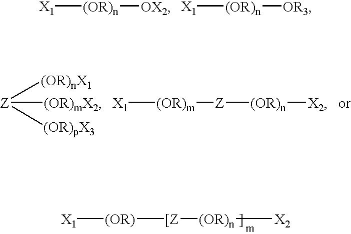
wherein X₁, X₂, X₃ are terminal groups at least one of which permits a curing reaction and wherein X₁, X₂, X₃ may be the same or different from each other; n, m and p may range from 2 to 1000, R is a straight or branched alkylene group having the formula (CR₁R₂)_{q} where q is an integer from 1 to 4, and R₁ and R₂ may independently be hydrogen and C₁₋₃ alkyl.

17. A pressure sensitive adhesive tape comprised of the adhesive of claim 1 on a backing material.

18. A pressure sensitive adhesive tape of claim 17 where a second side of the backing material is coated with a pressure sensitive adhesive.

19. A removable pressure sensitive adhesive tape comprised of the adhesive composition of claim 1 used in the assembly of touch screens to liquid crystal display screens.

20. A pressure sensitive adhesive tape comprised of the composition of claim 1 used in the assembly and mounting of removable graphics on a rigid or flexible substrate.

21. A removable pressure sensitive adhesive tape comprised of the composition of claim 1 used in the assembly and mounting of rigid or flexible display screens.

22. A removable pressure sensitive adhesive tape comprised of the composition of claim 1 used as a protective covering for various components during further processing procedures.

23. A pressure sensitive adhesive of claim 1 used in the bonding of transparent labels to glass or plastic surfaces.

24. A pressure sensitive adhesive of claim 1 used in the sealing of biological test plates.

25. A method of forming a pressure sensitive adhesive tape, comprising providing at least one radiation-curable oligomer and/or monomer on a substrate, said oligomer or monomer comprising a plurality of polyether segments comprising —CₐH₂ₐO— repeat units, wherein a is an integer of 1 to 4, and radiation-curing said oligomer and/or monomer in situ on said substrate, wherein said segments comprise from about 20 to about 85 percent by weight of said resulting polymer, and exposing said radiation-curable oligomer and/or monomer to radiation to form said radiation-cured pressure sensitive adhesive tape.

26. A method of claim 25, wherein said polyether segments are selected from the group consisting of —CH₂O—, —CH₂CH₂O—, —CH₂(CH₃)CHO—, —CH₂CH₂CH₂CH₂O—, —CH₂(C₂H₅)CHO—, and mixtures thereof.

27. A method of claim 25, wherein said polyether segments comprise from 35 to 85 percent by weight of said polymer.

28. A method of claim 25, comprising from about 15% to about 65% by weight of an epoxy containing compound.

29. A method of claim 25, comprising up to about 50% by weight of an acrylate containing compound.

30. A method of claim 25, comprising from about 15% to about 45% by weight of tackifier.

31. A method of claim 30, comprising from about 15% to about 35% by weight of tackifier.

32. A method of claim 25, comprising from about 15% to about 45% by weight of a plasticizer.

33. A method of claim 32, comprising from about 15% to about 35% by weight of a plasticizer.

34. A method of claim 25, comprising from about 0.1% to about 3% by weight of an initiator.

35. A method of claim 28, wherein said epoxy-containing compound is selected from the group consisting of aliphatic epoxides, cycloaliphatic epoxides, and epoxidized vinyl compounds.

36. A method of claim 30, wherein said tackifying compound is selected from the group consisting of terpene phenolics, alpha methyl styrene derived resins, rosin derived tackifiers, monomeric alcohols, oligomeric alcohols, and oligomeric glycols.

37. A method of claim 32, wherein said plasticizer is selected from the group consisting of terpene phenolics, rosin-derived plasticizers, and polyglycols.

38. A method of claim 34, wherein said initiator comprises an onium salt cationic photoinitiator.

39. A method of claim 34, wherein said initiator comprises a free radical photoinitiator.

40. A method of claim 25, wherein said radiation-curable oligomer or monomer is represented by one or more of the formulae 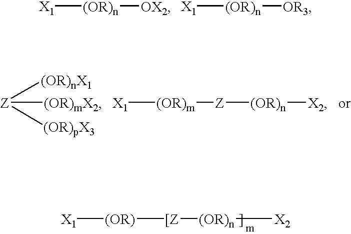
wherein X₁, X₂, X₃ are terminal groups at least one of which permits a curing reaction and wherein X₁, X₂, X₃ may be the same or different from each other; n, m and p may range from 2 to 1000, R is a straight or branched alkylene group having the formula (CR₁R₂)_{q} where q is an integer from 1 to 4, and R₁ and R₂ may independently be hydrogen and C₁₋₃ alkyl.

41. A light guide comprised of the adhesive of claim 1.
